(19) United States
(12) Patent Application Publication
(10) Pub. No.: US 2014/0328078 A1
(43) Pub. Date: Nov. 6, 2014

(54) VEHICLE HEADLAMP ASSMEBLY

(71) Applicant: FORD GLOBAL TECHNOLOGIES LLC, (US)

(72) Inventor: Bruce Preston Williams, Grosse Pointe Park, MI (US)

(73) Assignee: FORD GLOBAL TECHNOLOGIES LLC, Dearborn, MI (US)

(21) Appl. No.: 13/886,349

(22) Filed: May 3, 2013

(51) Int. Cl. F21S 8/10

(52) U.S. Cl. CPC F21S 48/15; F21S 48/1731
USPC 362/512

(57) ABSTRACT

One embodiment of a vehicle headlamp assembly may include a film, which may be configured to receive a voltage and have a variable opacity selectively adjusted between a transparent condition and an opaque condition in response to a magnitude of the voltage. The assembly may also have a lens carrying the film. The film may selectively block light from a light source, so as to display a predetermined graphic aligned with a surface contour of a vehicle structure adjacent to the lens.

### BACKGROUND

Conventional vehicle headlamp assemblies typically include a transparent lens that structurally conforms with a contour of adjacent vehicle surface structures and further include a concave reflector, which is visible through the transparent lens and appears recessed with respect to this contour. The parabolic shape of the reflector permits the assembly to direct light within a predetermined beam spread. However, the recessed concave reflector may be visibly disjointed and non-cohesive with respect to the contour formed by the adjacent vehicle surface treatments.

Certain vehicle headlamp assemblies may include bezels, such as shrouds or covers, which are intended to cover and surround optical elements of the assemblies, such as the reflectors. These bezels may harmonize the visible contour of the headlamp assembly with the surrounding vehicle exterior surface structure. However, these shrouds, covers and other bezels may consume packaging space within the headlamp assembly.

Accordingly, a need exists for a vehicle headlamp assembly that visually harmonizes with surrounding vehicle exterior structure and has improved packaging.

### SUMMARY

One embodiment of a vehicle headlamp assembly may include a film, which may be configured to receive a voltage and have a variable opacity selectively adjusted between a transparent condition and an opaque condition in response to a magnitude of the voltage. The assembly may also have a lens carrying the film. The film may selectively block light from a light source, so as to display a predetermined graphic aligned with a surface contour of a vehicle structure adjacent to the lens.

Another embodiment of a vehicle headlamp assembly may include a film, which may be configured to receive a voltage and further have a variable opacity selectively adjusted in response to a magnitude of the voltage. The assembly may also have a compound array lens that carries the film and directs light in one or more beam spread patterns. The film may selectively block a transmission of light from a light source to display a predetermined graphic, display a surface aligned with a vehicle structure adjacent to the compound array lens, or display both the design and surface.

### BRIEF DESCRIPTION OF THE DRAWINGS

FIG. 1A is an exploded perspective view of an exemplary vehicle headlamp assembly;

FIG. 1B is an enlarged view of an exemplary film for the assembly of FIG. 1A;

FIG. 2 is a perspective view of the assembly of FIG. 1A, depicting the assembly emitting a high beam light;

FIG. 3 is a perspective view of the assembly of FIG. 1A, depicting the assembly emitting a low beam light;

FIG. 4 is a perspective view of the assembly of FIG. 1A, depicting the assembly having a predetermined graphic for displaying a day running lamp condition;

FIG. 5A is a perspective view of a first exemplary assembly, depicting the assembly having a film with one predetermined graphic;

FIG. 5B is a perspective view of a second exemplary assembly, depicting the assembly having a film with another predetermined graphic;

FIG. 5C is a perspective view of a third exemplary assembly, depicting the assembly having a film with still another predetermined graphic;

FIG. 5D is a perspective view of a fourth exemplary assembly, depicting the assembly having a film with yet another predetermined graphic;

FIG. 5E is a perspective view of a fifth exemplary assembly, depicting the assembly having a film with still another predetermined graphic;

FIG. 6A is an enlarged schematic view of a first exemplary film for the assembly of FIG. 1B, depicting the film including one arrangement or pattern of shapes;

FIG. 6B is an enlarged schematic view of a second exemplary film for the assembly of FIG. 1B, depicting the film having another arrangement or pattern of shapes;

FIG. 6C is an enlarged schematic view of a third exemplary film for the assembly of FIG. 1B, depicting the film including yet another arrangement or pattern of shapes;

FIG. 6D is an enlarged schematic view of a fourth exemplary film for the assembly of FIG. 1B, depicting the film including still another arrangement or pattern of shapes;

FIG. 6E is an enlarged schematic view of a fifth exemplary film for the assembly of FIG. 1B, depicting the film having another arrangement or pattern of shapes;

FIG. 7 is a perspective view of the assembly of FIG. 1A, depicting the assembly having a predetermined graphic and a signaling device;

FIG. 8 is a schematic cross-sectional view of the film of FIG. 2, as taken along line 8-8;

FIG. 9A is a schematic cross-sectional view of another exemplary film for the assembly of FIG. 1B, permitting transmission of light through the film; and

FIG. 9B is a schematic cross-sectional view of still another exemplary film for the assembly of FIG. 1B, blocking transmission of light through the film.

### DETAILED DESCRIPTION

Referring now to the discussion that follows and also to the drawings, illustrative approaches are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

An exemplary vehicle headlamp assembly may visually conform with the surrounding front end body exterior to provide the vehicle with one continuous visual contour. The assembly may be efficiently packaged so as to increase the available space in the headlamp assembly, improve the aesthetic continuity of the vehicle exterior and transmit light or graphics in various ways for operating a vehicle. In this respect, the assembly may include a compound array lens that provides predetermined beam spread patterns and an active shutter mechanism, such as a film, for harmonizing the visual contour of the assembly in unison with the surrounding vehicle exterior structure. The lamp assembly may have substantially similar components and be integrated within other portions of the vehicle, such as a rear end body thereby providing a tail lamp assembly.

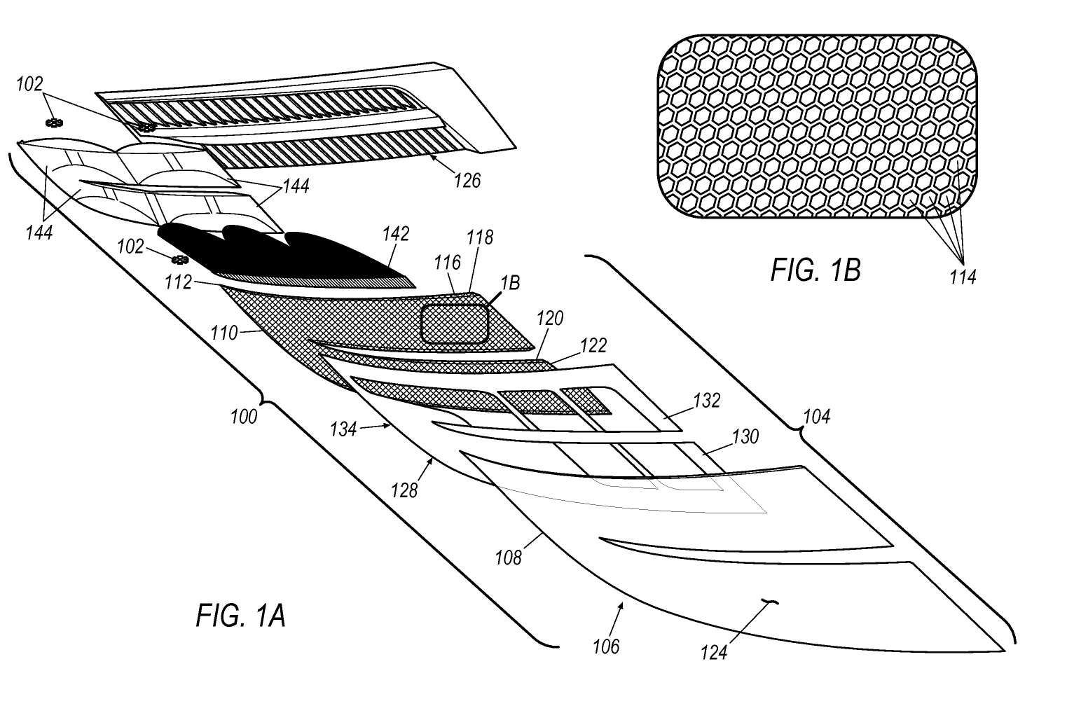

Referring to FIG. 1A, a vehicle headlamp assembly 100 (hereinafter “assembly”) may include one or more light sources 102, which in this form may be a light emitting diodes (hereinafter “LEDs”) for improving the packaging of the assembly and for also increasing the longevity of the light sources and surrounding components of the assembly that receive heat from the light sources 102. However, the light sources may instead be an incandescent bulbs or other suitable light sources.

The assembly 100 may also have a lens 104 that transmits at least a portion of light generated by the light sources. The lens 104 in this form may be a compound array lens 106 that includes an outer lens 108, which is a transparent single-piece panel. However, the outer lens may instead be made of two or more parts that are transparent, translucent or a combination thereof.

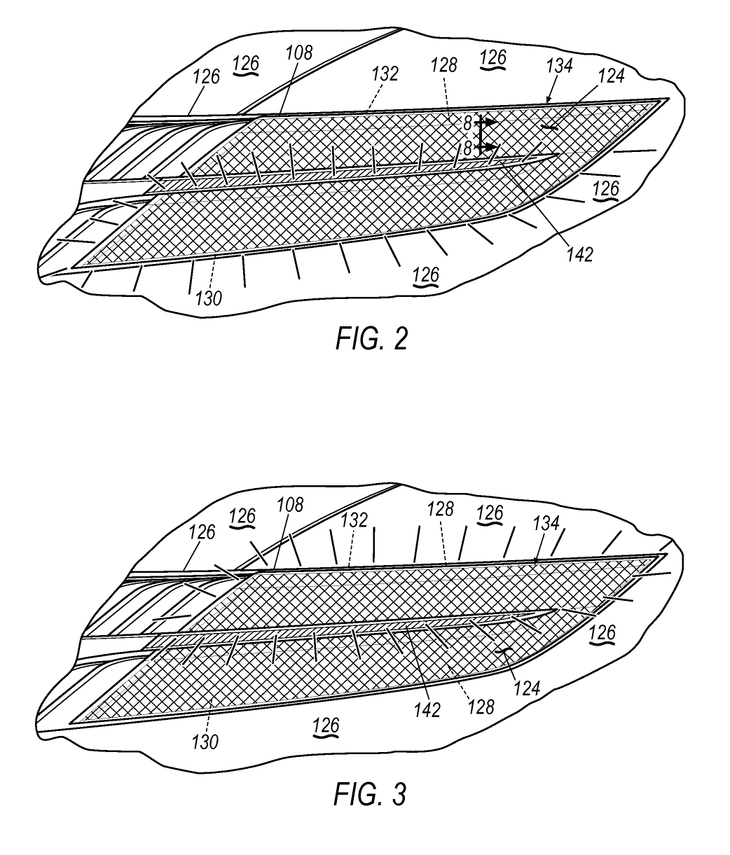

The lens 104 may also include an inner lens 110, which is coupled to the outer lens 108 and is a single piece panel 112 having an array of optical elements 114 configured to scatter light in one or more beam spread patterns. In particular, the array 114 may include a first plurality of optical elements 116 or lenses formed as integral portions of one section 118 of the panel 112. For example, the optical elements 116 may be configured to receive light from a high beam light source, such as an LED, and each of the optical elements 116 may be directed or otherwise configured to scatter light in a first beam spread pattern for the high beam (FIG. 2). Furthermore, the array 114 may also have a second plurality of optical elements 120 or lenses formed as integral portions of another section 122 of the single piece panel 112. By way of example, the first plurality of optical elements 116 may be configured to receive light from a low beam light source, such as another LED, and each of the optical elements 120 may be directed or otherwise configured to scatter light in a second beam spread pattern for the low beam (FIG. 3). In this respect, the optical elements 114 may be configured to direct the first beam spread pattern for the high beam within a range of angles directed farther upward than the second beam spread pattern for the low beam. However, the lens 104 may have an outer surface 124 configured to be aligned with an exterior surface of one or more peripheral vehicle surfaces elements 126 that are adjacent to the outer surface 124 of the lens 104. Examples of these peripheral vehicle surface elements may include a grill, a hood, a front quarter panel and a bumper.

The assembly 100 may also have an active shutter mechanism, which in this form is a film 128 selectively blocking light from the light source 102. In this respect, the film 128 may permit the LEDs to illuminate the road with high beams or low beams, or display parking signals or turning signals. In addition, the film 128 may be used in conjunction with the light sources to display a predetermined graphic aligned with an exterior contour of surrounding vehicle surface elements 126, so as to provide an assembly that visually conforms or aligns with the surrounding vehicle structure.

Referring back to FIG. 1A, the film 128 may be carried by the lens 104, sandwiched between, for example, the outer and inner lenses 108, 110 of the compound array lens 106. Of course, the film 128 may be carried by other suitable lenses having more or less than two components. Further, the film 128 may be configured to receive a voltage and have a variable opacity selectively adjusted between a transparent condition and an opaque condition, in response to a magnitude of the voltage.

FIGS. 1A through 4 illustrate the light source and the film being used in combination with one another to illuminate the road and improve continuity of the vehicle contour. As shown in the example depicted in FIGS. 1A and 2, when the a high beam light source receives power, a lower portion 130 of the film 128 may receive power to dispose that portion 130 in a transparent state, such that the high beam light source may transmit light through the film 128 and the lens 104.

Furthermore, as shown in the example illustrated in FIGS. 1A and 3, when the low beam light source receives power, an upper portion 132 of the film 128 may receive power to dispose that portion 132 in a transparent state, such that the low beam light source may transmit light through the film 128 and the lens 104. However, the low beam and high beam light sources may be disposed in various suitable portions of the assembly, and the same light source may receive various voltages to provide either the high beam or the low beam. Also, any portion of the film 128 or combination of portions may receive power and become transparent or translucent for transmitting light.

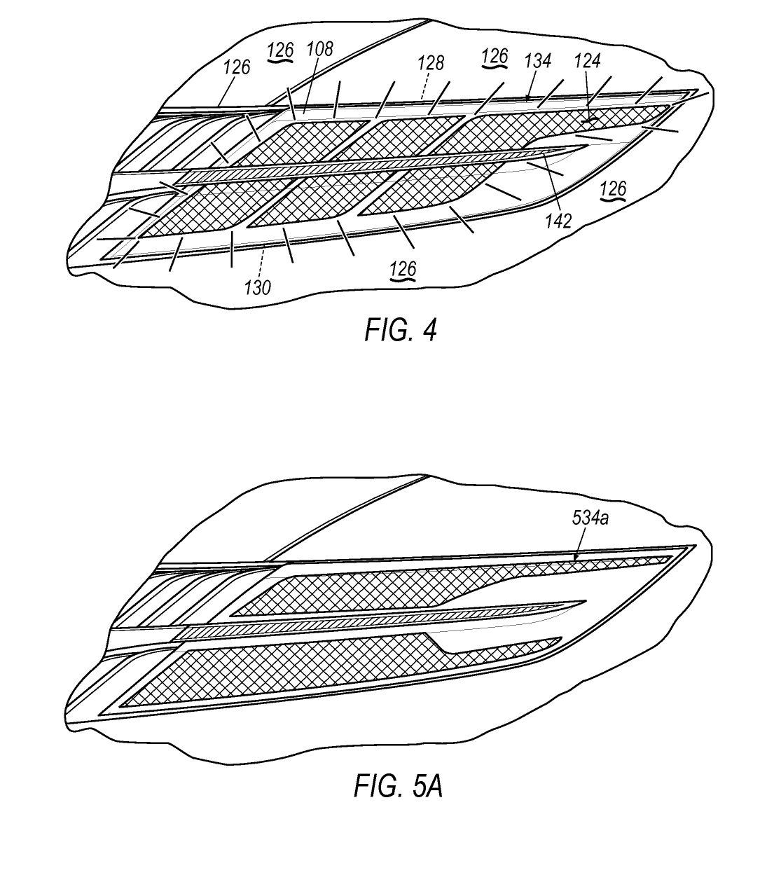

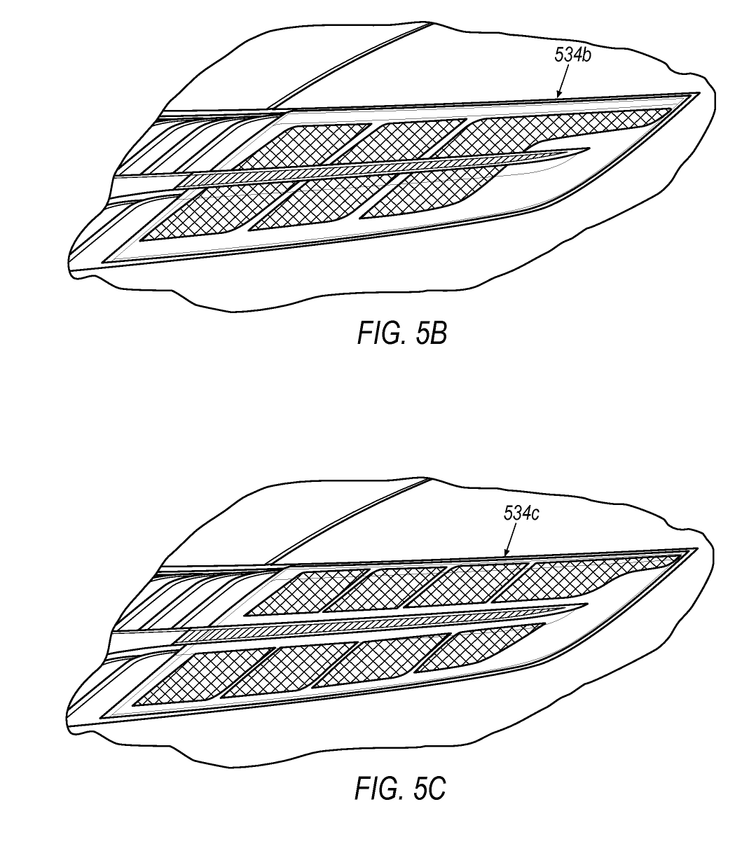

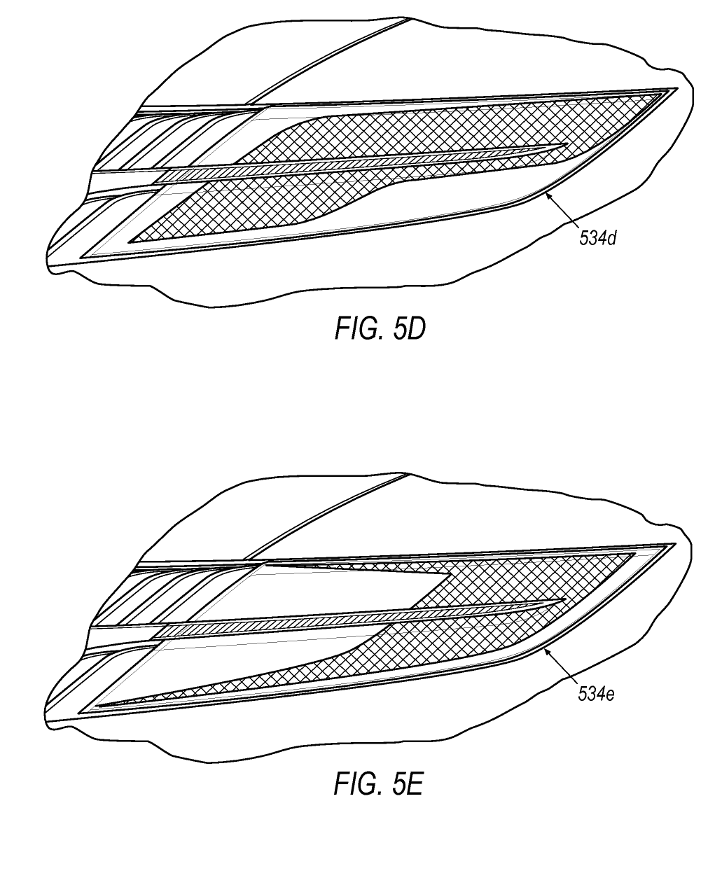

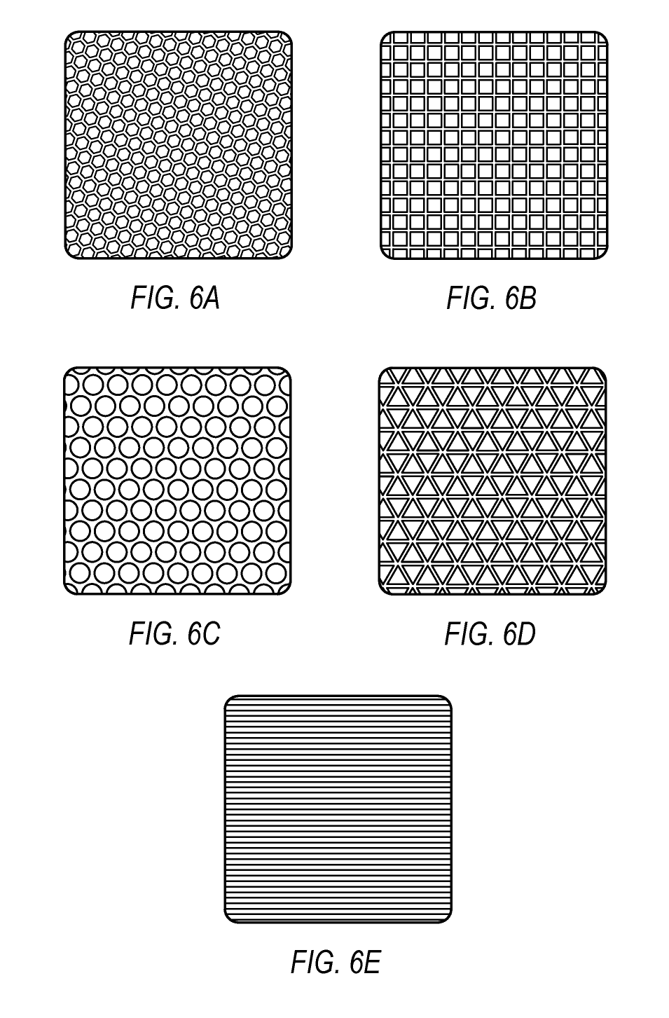

In the example depicted in FIGS. 1A and 4, when the light sources receive power for displaying a day running lamp, the film 128 may not receive any voltage or may receive less than a predetermined threshold, such that the film may be translucent and diffusely scatter light through a predetermined graphic 134 of the film 128. As exemplified in FIGS. 5A through 5E, the predetermined graphic 534a, 534b, 534c, 534d, 534e may be various shapes and patterns. Each pattern may be an arrangement of hexagons, squares, circles, triangles, lines, other suitable shapes or any combination thereof (FIGS. 6A through 6E). The patterned portions may be divided into one or more substantially vertical segments, substantially horizontal segments, substantially angled segments and further include various suitable borders with thickened portions on an inboard side, outboard side, upper portion, lower portion of any combination thereof. The thickened portions of the border may be a solid color and include vehicle badging or any suitable indicia or other markings

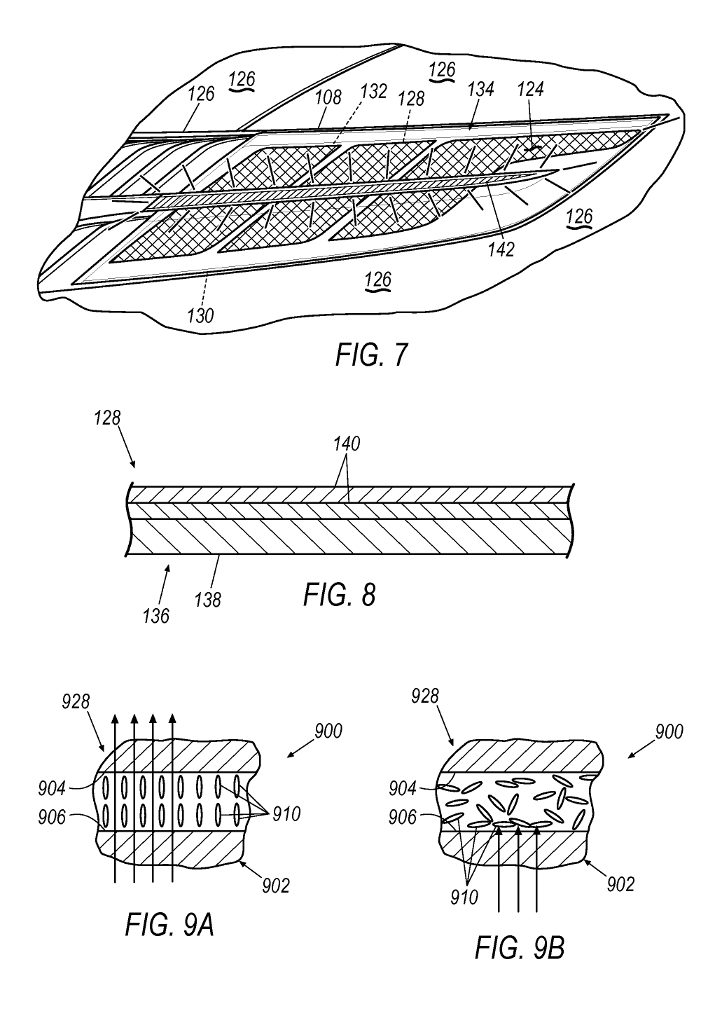

By way of yet another example, shown in FIGS. 1A and 7, when the light source 102 does not receive power, the film 128 may also not receive a voltage and the predetermined graphic or active portions of the film may be opaque in response to receiving no voltage. In this example, the opaque portions of the film 128 may provide the vehicle exterior structure with a visually continuous contour across the headlamp assembly with an apparent surface depth that is substantially equal to the surface depth of the surrounding vehicle exterior. However, the active portions may instead be translucent for scattering light while also maintaining a visual depth or lack thereof in unison with the surrounding vehicle surface structure.

Referring again to FIGS. 1A and 7, the assembly 100 may further include a signaling device 142, such as a turning signal or parking signal, which in this form includes an elongated light guide, light pipe or reflector disposed between the upper and lower portions 130, 132 of the film 128. This elongated structure may harmonize with, for example, an elongated surface element carried by a grill adjacent to the assembly 100.

Referring nor to FIG. 8, one embodiment of the film 128 may be an electrochromic device, such as a modified porous nano-crystalline film 128. One example of the film 128 may have a thickness of 0.25 millimeters. However, the film may have a thickness that is more or less than 0.25 millimeters. Further, the film 128 may include a substrate 136 having a transparent conductor 138 and a plurality of stacked porous layers 140 attached to the transparent conductor 138.

Referring to FIGS. 9A and 9B, another embodiment of the film 900 may be a suspended particle device 902, which includes two transparent layers 904, 906, a fluid 908 contained between the layers 904, 906 and a plurality of opaque particles 910 suspended in the fluid 908. As shown in FIG. 9A, the particles 910 may be aligned in a predetermined configuration to permit the transmission of light through the film in response to the film 928 receiving a predetermined voltage. As shown in FIG. 9B, these particles 910 may be misaligned with respect to one another in a random order so as to block the transmission of light directed through the film, in response to the film not receiving the predetermined voltage.

Referring back to FIG. 1A, the assembly 100 may further include one or more concave reflectors 144 surrounding a respective one of the light sources 102. In one example, the reflectors 144 may have a depth substantially shorter than conventional parabolic reflectors because the optical elements on the compound array lens are utilized to direct the light in the desired directions.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A vehicle headlamp assembly comprising:
a film configured to receive a voltage and have a variable opacity selectively adjusted between a transparent condition and an opaque condition in response to a magnitude of the voltage; and
a lens carrying the film;
wherein the film selectively blocks light from a light source, so as to at least one of display a predetermined graphic aligned with a vehicle structure adjacent to the lens.

2. The vehicle headlamp assembly of claim 1, wherein the film is a modified porous nano-crystalline film.

3. The vehicle headlamp assembly of claim 1, wherein the film has a thickness up to 0.25 millimeters.

4. The vehicle headlamp assembly of claim 1, wherein the film includes a substrate having a transparent conductor and a plurality of stacked porous layers attached to the transparent conductor.

5. The vehicle headlamp assembly of claim 1, wherein the film comprises:
at least two transparent layers;
a fluid contained between the at least two transparent layers; and
a plurality of opaque particles suspended in the fluid;
wherein the plurality of opaque particles are aligned in a predetermined configuration to permit the transmission of light through the film in response to the film receiving the voltage.

6. The vehicle headlamp assembly of claim 1, wherein the plurality of opaque particles are misaligned with respect to one another in a random order so as to block the transmission of light directed through the film, in response to the film not receiving a predetermined voltage.

7. The vehicle headlamp assembly of claim 1, wherein the predetermined graphic includes at least one of a pattern of hexagons, a pattern of squares and a pattern of triangles, which block the transmission of light.

8. The vehicle headlamp assembly of claim 1, wherein the light source is at least one light emitting diode.

9. The vehicle headlamp assembly of claim 8, further comprising at least one concave reflector surrounding the at least one light emitting diode.

10. A vehicle headlamp assembly comprising:
a film configured to receive a voltage and have a variable opacity in response to a magnitude of the voltage; and
a compound array lens carrying the film and directing light in at least one beam spread pattern;
wherein the film selectively blocks light from a light source, so as to at least one of display a predetermined graphic aligned with a vehicle structure adjacent to the lens.

11. The vehicle headlamp assembly of claim 10, wherein the compound array lens has an outer surface configured to be aligned with a peripheral vehicle exterior surface that is adjacent to the outer surface of the lens.

12. The vehicle headlamp assembly of claim 10, wherein the compound array lens includes an outer lens and an inner lens, with the film sandwiched between the inner and outer lenses.

13. The vehicle headlamp assembly of claim 12, wherein the inner lens is an array of optical elements configured to scatter light in the at least one beam spread pattern.

14. The vehicle headlamp assembly of claim 13, wherein the array of optical elements comprises:
a first plurality of optical elements configured to receive light from a high beam light source and the first plurality of optical elements are configured to scatter the light in a first predetermined beam spread pattern; and
a second plurality of optical elements configured to receive light from a low beam light source and the second plurality of optical elements are configured to scatter the light in a second beam spread pattern.

15. The vehicle headlamp assembly of claim 13, wherein the array is a single piece panel.

16. The vehicle headlamp assembly of claim 10, wherein the film has one of an opaque portion and a translucent portion displaying the predetermined graphic in response to the light source not receiving power and the film not receiving the voltage.

17. The vehicle headlamp assembly of claim 10, wherein the film has a translucent portion displaying the predetermined graphic in response to the light source receiving power and the film not receiving the voltage.

18. The vehicle headlamp assembly of claim 17, wherein the film has one of a translucent portion and a transparent portion for transmitting one of a high beam and a low beam in response to the light source receiving power and the film receiving the voltage to permit light to transmit through the film.

19. The vehicle headlamp assembly of claim 10, wherein the film is a modified porous nano-crystalline film.

20. The vehicle headlamp assembly of claim 10, wherein the film has a thickness up to 0.25 millimeters.
